(19) United States
(12) Patent Application Publication
(10) Pub. No.: US 2025/0065910 A1
(43) Pub. Date: Feb. 27, 2025

(54) Autonomous Driving Vehicle and Method of Controlling the Same

(71) Applicants: Hyundai Motor Company, Seoul (KR); Kia Corporation, Seoul (KR)

(72) Inventors: Bong Kwan Choi, Seoul (KR); Yea Bin Lee, Seoul (KR); Dae Sung Hwang, Uiwang-Si (KR); Da Yeon Park, Seoul (KR)

(21) Appl. No.: 18/776,576

(22) Filed: Jul. 18, 2024

(30) Foreign Application Priority Data
Aug. 25, 2023 (KR) 10-2023-0111961

(51) Int. Cl. B60W 60/00

(52) U.S. Cl. CPC B60W 60/001; B60W 2552/05

(57) ABSTRACT

An apparatus for controlling an autonomous driving of a vehicle is introduced. The apparatus may comprise, a controller and memory storing instructions, when executed by the controller, configured to cause the apparatus to, receive global positioning system (GPS) information, High Definition (HD) map information, road information, and sensor information, wherein the GPS information, the HD map information, and the road information are related to one or more roads ahead of the vehicle, generate, based on the GPS information, the HD map information, road information, and the sensor information, road change information, wherein the road change information is related to whether a driving road which the vehicle travels on is changed to or from a road, and wherein the road is associated with a preset class, and output, based on the road change information, a signal for controlling the autonomous driving of the vehicle.

This application claims the benefit of priority to Korean Patent Application No. 10-2023-0111961, filed on Aug. 25, 2023, which is hereby incorporated by reference in its entirety.

### TECHNICAL FIELD

The present disclosure relates to an autonomous vehicle and a method of controlling the autonomous vehicle.

### BACKGROUND

An autonomous vehicle refers to a vehicle that drives itself by recognizing a driving environment on its own, determining a potential risk, controlling a driving path, and minimizing the driver's driving operations.

The autonomous vehicle may ultimately be a vehicle that is capable of driving, steering, and parking without human influence, and autonomous driving technology, which is the core foundation of autonomous vehicles, may focus on vehicles that have the highest advanced level of operating itself without active control or monitoring by drivers.

However, a concept of autonomous vehicles may relate to automation, an intermediate step to a fully autonomous vehicle, which corresponds to a goal-oriented concept premised on the mass production and commercialization of fully autonomous vehicles.

According to the Society of Automotive Engineers (SAE), the automation level of autonomous vehicles is classified from level 0 to level 5.

Level 3 autonomous driving, unlike level 4 or higher autonomous driving, frequently switches control between the human driver and the system during driving, which may cause more complex problems than fully autonomous driving.

Level 3 autonomous driving, unlike level 4 or higher autonomous driving where the system is responsible for the entire driving process, needs to be always ready to drive without imposing on the driver an obligation to keep eyes forward and control the vehicle.

In addition or alternative, level 3 autonomous driving allows autonomous driving to be performed only in an operational design domain (ODD), which indicates a situation where certain conditions related to weather, roads, and communication are met, and thus switches a manual driving mode if a vehicle is not in the ODD state. That is, if the vehicle is out of the ODD state while driving in an autonomous driving mode, the driver is required to take over the control of the vehicle.

In the case of an accident that occurs while an autonomous vehicle is driving in the autonomous driving mode in the ODD state, which is referred to hereinafter as an autonomous driving accident, accident liability issues unique to autonomous driving vehicles may arise, and thus efforts to prevent such autonomous driving accidents may need to be made to avoid them in advance.

In particular, improved vehicle control is required in an ODD state where a highway driving pilot (HDP), a level 3 autonomous driving technology that is considered “highway autonomous driving,” is operable. However, in the case where global positioning system (GPS) error is large, there have been cases where the precision positioning becomes ready, i.e. a precision positioning state becomes a ready state (“Ready”) on a road that is not a car-only road where the HDP is operable.

For example, due to a high GPS error in environments under overpasses or with high walls, though an autonomous vehicle drives on a road other than a car-only road in reality, the controller may erroneously determine that the vehicle drives on the car-only road and set the precision positioning ready and thus activate the HDP.

As described above, if the precision positioning state is ready on a road that is not the car-only road, an autonomous vehicle may activate the HDP in an unexpected environment, which may pose a risk that may threaten the driver's safety.

### SUMMARY

According to the present disclosure, an apparatus for controlling an autonomous driving of a vehicle, the apparatus may comprise, a controller and memory storing instructions, when executed by the controller, configured to cause the apparatus to, receive global positioning system (GPS) information, High Definition (HD) map information, road information, and sensor information, wherein the GPS information, the HD map information, and the road information are related to one or more roads ahead of the vehicle, generate, based on the GPS information, the HD map information, road information, and the sensor information, road change information, wherein the road change information is related to whether a driving road which the vehicle travels on is changed to or from a road, and wherein the road is associated with a preset class, and output, based on the road change information, a signal for controlling the autonomous driving of the vehicle.

The apparatus of claim 1, wherein the instructions, when executed by the controller, are further configured to cause the apparatus to, set, based on the road change information, a precision positioning state of the vehicle to be a ready state of the vehicle.

The apparatus of claim 2, wherein the instructions, when executed by the controller, are further configured to cause the apparatus to, output the GPS information, and set, based on the vehicle being determined to be in a state before entering a road associated with the preset class, the precision positioning state to be a not-ready state of the vehicle.

The apparatus of claim 2, wherein the instructions, when executed by the controller, are further configured to cause the apparatus to, based on the vehicle being determined to be in a state after exiting a road associated with the preset class, estimate a location of the vehicle by applying dead reckoning (DR) to a previous location, and set the precision positioning state to be a not-ready state of the vehicle.

The apparatus of claim 4, wherein the instructions, when executed by the controller, are further configured to cause the apparatus to, estimate, based on using the DR, the location of the vehicle within a preset distance.

The apparatus of claim 5, wherein the instructions, when executed by the controller, are further configured to cause the apparatus to, maintain, based on using the DR, the precision positioning state as the ready state until the vehicle is within the preset distance, and set the precision positioning state to be the not-ready state after the vehicle is beyond the preset distance.

The apparatus of claim 1, wherein the HD map information may comprise a road link property and a lane link geometry of the road associated with the preset class, and the road information may comprise a road identification (ID) of the road associated with the preset class.

The apparatus of claim 7, wherein the instructions, when executed by the controller, are further configured to cause the apparatus to, based on the ID indicating a null signal, set an entry flag to be a first entry flag, wherein the entry flag indicates information associated with situations under which the vehicle is entering a road, based on the ID being changed from an ID indicating a general road to an ID indicating a road associated with the preset class, set the entry flag to be a second entry flag, and based on the ID being changed to an ID indicating a road associated with the preset class, set the entry flag to be a third entry flag.

The apparatus of claim 8, wherein the first entry flag indicates a case where the vehicle is not entering onto a road associated with the preset class, the second entry flag indicates a case where the vehicle is entering onto a road associated the preset class, and the third entry flag indicates a case where a road of the preset class is changed to another road associated with the preset class due to a change of a driving path of the vehicle.

The apparatus of claim 1, wherein the road information may comprise information related to a most likely road, wherein the most likely road is determined to be most likely to be travelled on by the vehicle among a plurality of roads at a road junction or bifurcation ahead.

According to the present disclosure, a method for controlling an autonomous driving of a vehicle, the method may comprise, receiving, by a controller, global positioning system (GPS) information, High Definition (HD) map information, road information, and sensor information, wherein the GPS information, the HD map information, and the road information are related to one or more roads ahead of the vehicle, and generating, by the controller and based on the GPS information, the HD map information, the road information, and the sensor information, road change information, wherein the road change information is related to whether a driving road which the vehicle travels on is changed to or from a road, and wherein the road is associated with a preset class, and outputting, based on the road change information, a signal for controlling the autonomous driving of the vehicle.

The method of claim 11, may further comprise setting, based on the road change information, a precision positioning state of the vehicle to be a ready state of the vehicle.

The method of claim 12, may further comprise, outputting the GPS information, and setting, based on the vehicle being determined to be in a state before entering a road associated with the preset class, the precision positioning state to be a not-ready state of the vehicle.

The method of claim 12, may further comprise, based on the vehicle being determined to be in a state after exiting a road associated with the preset class, estimating a location of the vehicle by applying dead reckoning (DR) to a previous location, and setting the precision positioning state to be a not-ready state of the vehicle.

The method of claim 14, may further comprise estimating, based on using the DR, the location of the vehicle within a preset distance.

The method of claim 15, may further comprise, maintaining, based on using the DR, the precision positioning state to be the ready state until the vehicle is within the preset distance, and setting the precision positioning state to be the not-ready state after the vehicle is beyond the preset distance.

The method of claim 11, wherein the HD map information may comprise a road link property and a lane link geometry of the road associated with the preset class, and the road information may comprise a road identification (ID) of the road associated with the preset class.

The method of claim 17, may further comprise, based on the ID indicating a null signal, setting an entry flag to be a first entry flag, wherein the entry flag indicates information associated with situations under which the vehicle is entering a road, based on the ID being changed from an ID indicating a general road to an ID indicating a road associated the preset class, setting the entry flag to be a second entry flag, and based on the ID being changed to an ID indicating a road associated with the preset class, setting the entry flag to be a third entry flag.

The method of claim 18, wherein the first entry flag indicates a case where the vehicle is not entering onto a road associated with the preset class, the second entry flag indicates a case where the vehicle is entering onto a road associated with the preset class, and the third entry flag indicates a case where a road associated with the preset class is changed to another road associated with the preset class due to a change of a driving path of the vehicle.

According to the present disclosure, a non-transitory computer-readable medium storing a program or instructions, when executed, cause performance of a method for controlling an autonomous driving of a vehicle, the method may comprise, receiving, by a controller, global positioning system (GPS) information, High Definition (HD) map information, road information, and sensor information, wherein the GPS information, the HD map information, and the road information are related to one or more roads ahead of the vehicle, and generating, by the controller and based on the GPS information, the HD map information, the road information, and the sensor information, road change information, wherein the road change information is related to whether a driving road which the vehicle travels on is changed to or from a road, and wherein the road is associated with a preset class, and outputting, based on the road change information, a signal for controlling the autonomous driving of the vehicle.

### BRIEF DESCRIPTION OF THE DRAWINGS

FIG. 1 shows an example of an autonomous vehicle according to an example of the present disclosure.

FIG. 2 shows an example of an ego vehicle location estimator according to an example of the present disclosure.

FIG. 3 shows examples of the operations of an ego vehicle location estimator according to an example of the present disclosure.

FIG. 4 shows examples of a shape of an entry lane link on a real map according to an example of the present disclosure.

FIG. 5 shows an example of determining the passage of an entry lane link according to an example of the present disclosure.

FIG. 6 shows examples of a shape of an exit lane link on a real map according to an example of the present disclosure.

FIG. 7 shows an example of determining the passage of an exit lane link according to an example of the present disclosure.

FIG. 8 shows an example of a method of determining whether a vehicle is located on a main road according to an example of the present disclosure.

FIG. 9 shows an example of a method of determining whether a vehicle is located on a main road according to another example of the present disclosure.

FIG. 10 shows an example of a flowchart showing operations of an autonomous driving controller according to an example of the present disclosure.

FIG. 11A, FIG. 11B, FIG. 11C, FIG. 12A, FIG. 12B, FIG. 13A, FIG. 13B, FIG. 13C, and FIG. 13D shows examples of simulations according to an example of the present disclosure.

### DETAILED DESCRIPTION OF THE DISCLOSURE

Hereinafter, examples of the present disclosure will be described in detail with reference to the accompanying drawings. The examples are not construed as limited to the disclosure and should be understood to include all changes, equivalents, and replacements within the idea and the technical scope of the disclosure.

In the description of the examples, when a layer (or film), region, pattern, or structure is described as formed “above/on” or “below/under” a substrate, layer (or film), region, pattern, or pad, it may be construed that they are in direct contact, or they are in indirect contact with one or more other elements disposed therebetween.

In this case, the use of “above/on” or “below/under” may be based on what is shown in the accompanying drawings, and these terms are used only to indicate a relative positional relationship between elements for the convenience of description, but may not be used to limit the actual positions of the elements.

In addition, terms including ordinal numbers such as “first,” “second,” and the like may be used herein to describe various elements, the elements are not limited by these terms. These terms are only used to distinguish one element from another.

Hereinafter, according to an example, an autonomous vehicle and a method of controlling the autonomous vehicle, which may determine a road change state e.g. a car-only road entry/exit state (which is associated with an entry into and an exit from a road of a preset class, e.g. a car-only road) of the autonomous vehicle driving on a road that is not the car-only road and may prevent a ready state (“Ready”) of precision positioning from being activated on a general road that is not the car-only road based on a resulting value from the determining, will be described with reference to the accompanying drawings.

In the description of the examples of the present disclosure, the car-only road may mean a road satisfying conditions for the HDP operable ODD state, e.g. an exclusive road for vehicles like highway or expressway. Also, the car-only road may be referred to as a “main road” and a road other than the car-only road as a “general road” or “else road.”

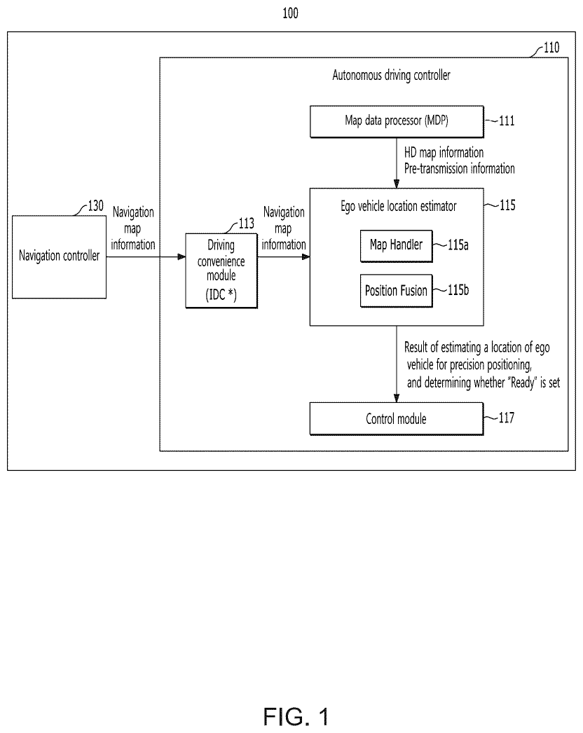

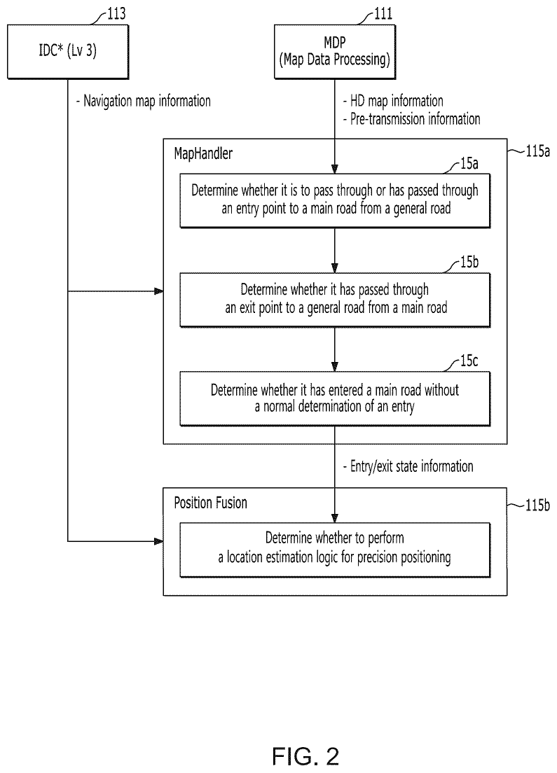

FIG. 1 shows an example of an autonomous vehicle according to an example of the present disclosure, and FIG. 2 shows an example of an ego vehicle location estimator according to an example of the present disclosure.

Referring to FIGS. 1 and 2, according to an example of the present disclosure, an autonomous vehicle 100 may include an autonomous driving controller 110 and a navigation controller 130. The autonomous vehicle 100 described herein may also be referred to as an ego vehicle.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.).

The autonomous driving controller 110 may include a map data processor 111, a driving convenience module 113, an ego vehicle location estimator 115, and a control module 117. The autonomous driving controller 110 may also be referred to as an integrated autonomous driving controller.

The autonomous driving controller 110 may receive global positioning system (GPS) information provided by the navigation controller 130, HD map information, sensor data, and the like and determine whether the input data is valid.

In this case, if the input data is determined not to be valid, the autonomous driving controller 110 may output information indicating that there is no location information and set a precision positioning state to be a not-ready state (“Not Ready”).

In contrast, if the input data is determined to be valid, the autonomous driving controller 110 may set a GPS to be in a ready state (“Ready”).

In this case, if the GPS is not in the ready state while the input data is determined to be valid, the autonomous driving controller 110 may determine that the GPS information is invalid and output information indicating that there is no location information, and may set the precision positioning state to be the not-ready state.

If the HD map information is not input while the GPS is in the ready state, the autonomous driving controller 110 may output the GPS information as is because only the GPS information is valid. The GPS information may also be referred to as GPS location information.

Accordingly, since the autonomous driving controller 110 has only the GPS information and no HD map information, it may set the precision positioning state to be the not-ready state.

If receiving the HD map information while the GPS is in the ready state, the autonomous driving controller 110 may determine whether the ego vehicle enters a main road from a general road. For example, if it is before the ego vehicle enters the main road from the general road, the autonomous driving controller 110 may output the GPS information and set the precision positioning state to be the not-ready state.

That is, if it is before the ego vehicle enters the main road from the general road, the autonomous driving controller 110 may output the GPS information as is because an input HD map does not indicate a road on which the ego vehicle is currently driving. In this case, since the GPS information does not meet the specifications, the autonomous driving controller 110 may set the precision positioning state to be the not-ready state.

The map data processor 111 may generate the HD map information including roads, lanes, facilities, and the like around the ego vehicle, and pre-transmission information, under the control of the control module 117. In this case, the HD map may include various road data necessary for autonomous driving, which includes, for example, lanes (e.g., a number and orientation of lanes), traffic lights (e.g., location and status of traffic lights), signs (e.g., location and status of road signs), road conditions (e.g., potholes, bumps, road texture), traffic flow (e.g., traffic density, speeds, patterns), obstacles and hazard information (e.g., construction zones, debris, pedestrians), location of crosswalks and pedestrian paths, layouts of intersections, and roadside features (e.g., barriers, guardrails, sidewalks, edges).

If there is a junction or bifurcation of roads ahead, the map data processor 111 may determine one among the road ahead which the vehicle is expected to travel on according to a preset rule installed therein. The preset rule includes selecting among the roads ahead the one which is on the travel path predetermined to a destination, and/or selecting one among the roads based on a preset priority rule by which the priority order may be ordered as: freeway (or highway), arterial road (or urban highway/car-only road), country road (or national highway/state-supported local road). The map data processor 111 may transmit to the ego vehicle location estimator 115 the pre-transmission information in advance before entering a car-only road which the vehicle is expected to travel on.

The HD map, which corresponds to road data or HD map information, may include, for example, information about the height, curvature, and slope of a road, lanes, road facilities, and various changes on the road. The HD map information may include, for example, road link property data (“RoadLink Property”), lane link geometry data (“LaneLink Geometry”), and the like of entry and exit roads. The pre-transmission information may include, for example, a road identification (ID) without being limited thereto.

The map data processor 111 may detect and analyze real-time road change information through the ego vehicle that is driving or stopped on a road, and then obtain a corresponding latest HD map, under the control of the control module 117. The map data processor 111 may receive, in real time, the latest HD map within a predetermined GPS range based on the GPS information provided by the navigation controller 130, under the control of the control module 117.

That is, the map data processor 111 may receive the GPS information provided by the navigation controller 130 and the HD map information processed based on the GPS information, under the control of the control module 117. The processed HD map information may be HD map information associated with an area separated a predetermined distance away from the GPS information.

As the map data processor 111 receives the HD map information related to the surroundings of the GPS information based on the GPS information, it may be possible to significantly reduce the amount of data of the HD map information and enable smooth real-time data transmission.

The driving convenience module 113 may receive the GPS information and navigation map information from the navigation controller 130, which will be described below, and may operate various advanced driver assistance functions including, for example, highway driving assistance and navigation-based smart cruise control, under the control of the control module 117.

The ego vehicle location estimator 115 may analyze the HD map information and/or the pre-transmission information provided by the map data processor 111 and the GPS information and the navigation map information provided by the navigation controller 130, generate entry/exit state information based on a resulting value obtained from the analyzing, and estimate a location for precision positioning based on the generated entry/exit state information, under the control of the control module 117.

The ego vehicle location estimator 115 may include a map handler 115a and a position fusion 115b.

The map handler 115a may generate the entry/exit state information using at least one of the HD map information, the pre-transmission information, or the navigation map information, under the control of the control module 117. The navigation map information may include road type information about a type of a road on which the ego vehicle is currently driving. The road type information may include, for example, information about a general road (else), a car-only road (main), an interchange (IC), a junction (JC), and the like.

In addition or alternative, the entry/exit state information may include information 15a obtained by determining whether the ego vehicle is to pass or has passed an entry point from a general road to a main road, information 15b obtained by determining whether the ego vehicle has passed an exit point from the main road to the general road, and information 15c obtained by determining whether the ego vehicle has entered the main road without determining a normal entry or exit. This will be described in detail below.

In addition or alternative, the map handler 115a may analyze the provided HD map information, pre-transmission information, and navigation map information to determine whether the ego vehicle enters a second road from a first road or exits from the second road to the first road, under the control of the control module 117. The first road may also be referred to herein as a general road, and the second road may also be referred to herein as a main road or a car-only road.

A movement of an ego vehicle from the first road to the second road may also be described herein as entering the second road from the first road (i.e., an entry into the second road from the first road). For example, the ego vehicle may enter the main road from the general road.

In addition or alternative, a movement of an ego vehicle from the second road to the first road may also be described as exiting from the second road to the first road (i.e., an exit from the second road to the first road). For example, the ego vehicle may exit from the main road to the general road.

As described above, the map handler 115a may determine the entry/exit state information using at least one of the HD map information, the pre-transmission information, or the navigation map information, and provide the entry/exit state information to the position fusion 115b, under the control of the control module 117.

The position fusion 115b may analyze a precision positioning location using the entry/exit state information and the navigation map information, and set the precision positioning location or the precision positioning state to be the not-ready state based on a result of the analyzing, under the control of the control module 117.

For example, the position fusion 115b may analyze a location of the ego vehicle using the entry state information, the exit state information, an entry flag for an entering situation, or an exit flag for a state after exiting, and may thereby determine the precision positioning location more accurately.

The control module 117 may control at least one other component (e.g., a hardware component (e.g., an interface and/or memory) and/or a software component (e.g., software program)) of the autonomous driving controller 110 and perform various data processing and computation. For example, the control module 117 may control overall the map data processor 111, the driving convenience module 113, and the ego vehicle location estimator 115.

The control module 117 may also be referred to as a processor, a controller, a control device, a control circuit, and the like.

Additionally or alternatively, the control module 117 may include a memory, although not shown. The memory may store various data used by at least one component of the map data processor 111, the driving convenience module 113, and the ego vehicle location estimator 115, in addition or alternative to the autonomous driving controller 110, for example, input data and/or output data for software programs and instructions related thereto.

The memory may include a non-volatile memory such as cache, read-only memory (ROM), programmable ROM (PROM), erasable PROM (EPROM), and electrically EPROM (EEPROM), and/or a volatile memory such as random-access memory (RAM).

The navigation controller 130 may provide the navigation map information to the autonomous driving controller 100. The navigation controller 130 may receive the navigation map information from the outside. However, examples are not limited thereto, and the navigation controller 130 may receive the navigation map information previously stored in the memory.

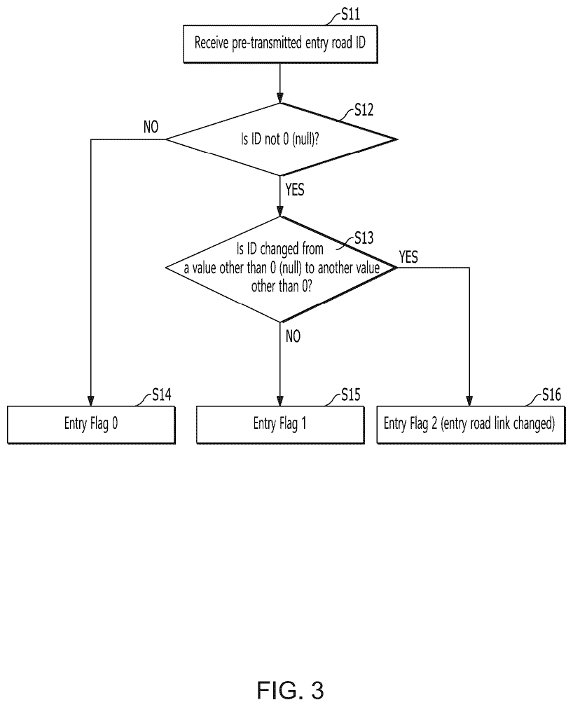

FIG. 3 shows examples of the operations of an ego vehicle location estimator according to an example of the present disclosure.

Referring to FIG. 3, the ego vehicle location estimator 115 may generate entry/exit state information using at least one of provided HD map information, pre-transmission information, or navigation map information, under the control of the control module 117.

For example, the map handler 115a may determine an expected entry into a second road from a first road, under the control of the control module 117. That is, the map handler 115a may determine an expected entry into a main road from a general road, under the control of the control module 117.

The map handler 115a may set an entry flag (“Entry Flag”) under the control of the control module 117. The entry flag may include a first entry flag (“Entry Flag 0”) to a third entry flag (“Entry Flag 2”).

As shown in FIG. 3, in step S11, the map handler 115a may receive an entry road ID through the pre-transmission information, under the control of the control module 117.

The map handler 115a may analyze the provided entry road ID in step S12, and if the entry road ID indicates “0 (or null i.e. absence of ID signal)” (No in S12) as a result of the analysis, may set the entry flag to be the first entry flag (Entry Flag 0) in step 14, under the control of the control module 117. In this case, the first entry flag (Entry Flag 0) may indicate not being an entry situation and may indicate a case where there is no signal input for the ID.

The map handler 115a may analyze the provided entry road ID in step S12, and if the entry road ID is not “0” (Yes in S12) as the result of the analysis, may determine whether the entry road ID indicates “1” or a “value other than 1” in step S13, under the control of the control module 117. In this description, the entry road ID is a number, but not limited thereto.

For example, if the entry road ID is a “number A that is not 0” (No in S13), the map handler 115a may set the entry flag to be the second entry flag (Entry Flag 1) in step S15, under the control of the control module 117. For example, if the entry road ID is “1” (No in S13), the map handler 115a may set the entry flag to be the second entry flag (Entry Flag 1) in step S15, under the control of the control module 117. In this case, the second entry flag (Entry Flag 1) may indicate an entry situation and may indicate a case where the entry road ID of an entry road into which an entry is to be made is received.

In contrast, if the entry road ID is changed to a “number B that is not 0 from the number A that is not 0” (Yes in S13), the map handler 115a may set the entry flag to be the third entry flag (Entry Flag 2) in step S16, under the control of the control module 117. For example, if the entry road ID is “a value other than 0 and 1” (Yes in S13), the map handler 115a may set the entry flag to be the third entry flag (Entry Flag 2) in step S16, under the control of the control module 117. In this case, the third entry flag (Entry Flag 2) may indicate a case where an entry situation was predicted in a previous time period but the expected path has been changed and an entry road into which an entry is to be made is predicted differently than previously expected.

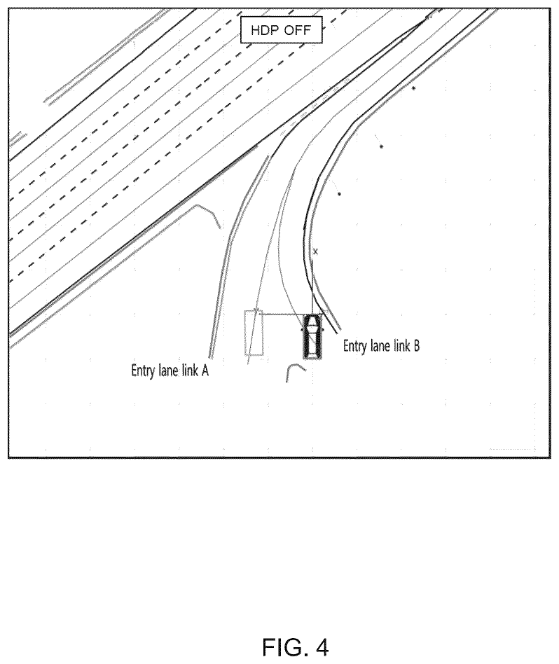

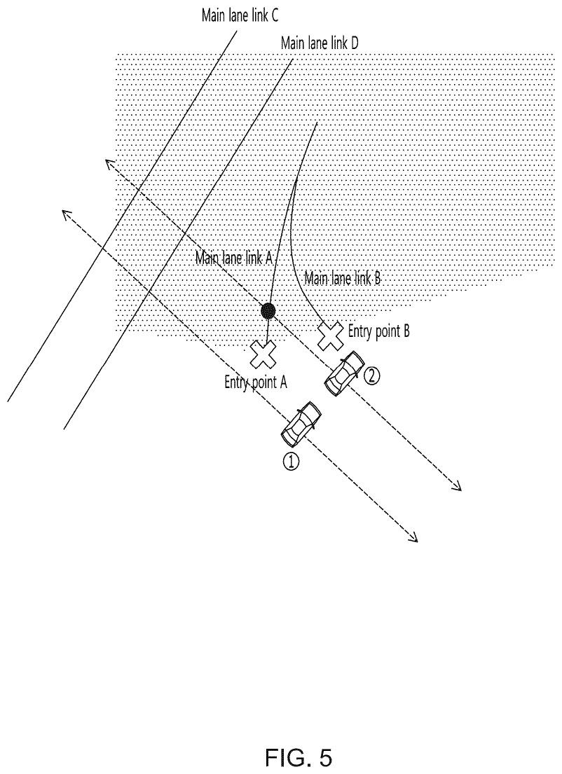

FIG. 4 shows examples of a shape of an entry lane link on a real map according to an example of the present disclosure, and FIG. 5 shows an example of determining the passage of an entry lane link according to an example of the present disclosure.

The map handler 115a may set an entry lane link and a main lane link by analyzing provided HD map information. In this case, the map handler 115a may distinguish between the entry lane link and the main lane link based on whether there is an entry property in the lane links, under the control of the control module 117.

As shown in FIGS. 4 and 5, a HD map may include at least one main lane link and at least one entry lane link.

For example, the at least one entry lane link may include an entry lane link A and an entry lane link B. An entry point A may be connected to the entry lane link A, and an entry point B may be connected to the entry lane link B.

The map handler 115a may determine a second road through an entry point to the second road from a first road, under the control of the control module 117. That is, the map handler 115a may determine a main road through an entry point to the main road from a general road, under the control of the control module 117.

The map handler 115a may perform calculations on all lanes of an entry road when passing the entry point from the general road to the main road, under the control of the control module 117. In this case, the entry point, which is a point to be calculated, may vary depending on an input point of the HD map.

The map handler 115a may draw or generate a perpendicular foot on the entry lane link to determine an entry flag (Flag), under the control of the control module 117. The perpendicular foot may be defined as a straight line perpendicular to the heading of an ego vehicle (e.g., 100).

In this case, the map handler 115a may draw the perpendicular foot with respect to the entry lane link having the entry property, under the control of the control module 117.

For example, as shown in FIG. 5, if a perpendicular foot L1 for determining the entry flag (Flag) is drawn in a case where the ego vehicle is located at [symbol] , the perpendicular foot L1 does not overlap the entry lane link A or the entry lane link B, and thus there may not be an overlapping point “H.”

In contrast, if a perpendicular foot L2 for determining the entry flag (Flag) is drawn in a case where the ego vehicle is located at [symbol] , the perpendicular foot L2 overlaps the entry lane link A and there may be an overlapping point “H.”

If the overlapping point “H” is present, the map handler 115a may determine an entry into the main road based on whether “H” is in a main road determination area, under the control of the control module 117.

For example, if the overlapping point “H” is within the main road determination area, the map handler 115a may determine that the ego vehicle enters the main road by passing through the entry point from the general road to the main road, under the control of the control module 117. In this case, the map handler 115a may change the second entry flag (Entry Flag 1) to the first entry flag (Entry Flag 0), under the control of the control module 117. That is, the map handler 115a may determine that the ego vehicle has passed a point that was predicted as the entry point, and may not predict an entry afterward, under the control of the control module 117.

In contrast, if the overlapping point “H” is not within the main road determination area, the map handler 115a may determine that the ego vehicle does not enter the main road by not passing through the entry point from the general road to the main road, under the control of the control module 117. In this case, the map handler 115a may change the second entry flag (Entry Flag 1) to the third entry flag (Entry Flag 2), under the control of the control module 117.

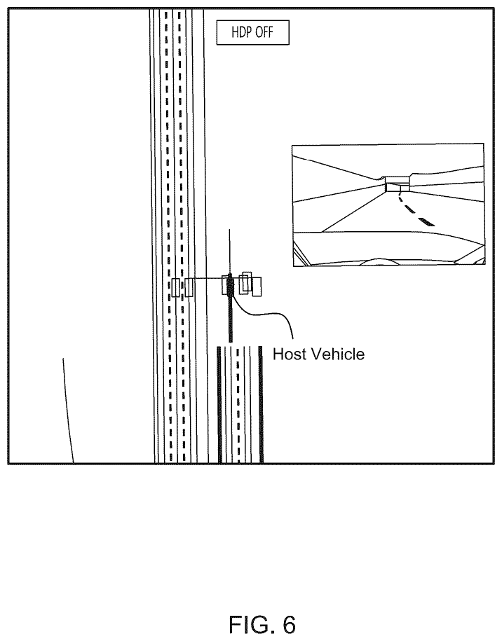

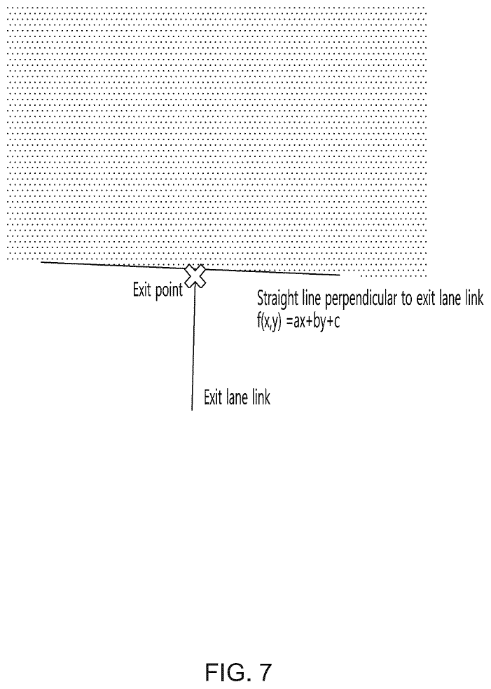

FIG. 6 shows examples of a shape of an exit lane link on a real map according to an example of the present disclosure, and FIG. 7 shows an example of determining the passage of an exit lane link according to an example of the present disclosure.

The map handler 115a may set an exit lane link by analyzing provided HD map information, under the control of the control module 117.

The map handler 115a may set an exit flag (Exit Flag) under the control of the control module 117. The exit flag may include a first exit flag (Exit Flag 0) to a third exit flag (Exit Flag 2).

The map handler 115a may calculate geometry using a positioning location without a change, under the control of the control module 117. This is because, unlike an entry situation, the reliability of positioning quality is relatively high in an exit situation. For example, when a property of an exit road corresponds to a property of a service area, the map handler 115a may store service area information in advance and use it.

As shown in FIGS. 6 and 7, the map handler 115a may perform calculations to determine an exit as follows, under the control of the control module 117.

The map handler 115a may determine an exit road if there is no forward connectivity from a main road and calculate an equation of a straight line perpendicular to the exit lane link based on a result of the determination, under the control of the control module 117.

The equation of the straight line is as follows.

$$\begin{matrix}f ( x , y ) = ax + by + c & f ( x , y ) = ax + by + c\end{matrix} \qquad [ Equation 1 ]$$

The map handler 115a may determine whether a location (P(x₁,y₁)P(x₁,y₁)) of an ego vehicle (e.g., 100) and another point (P(x₂,y₂)P(x₂,y₂)) of the exit lane link are present in the same area, under the control of the control module 117.

For example, if a resulting value obtained by calculating the location (f(x₁,y₁)f(x₁,y₁)) of the ego vehicle and the other point (f(x₂,y₂)f(x₂,y₂)) of the exit lane link is less than zero (0), the map handler 115a may determine that they are present in different areas, under the control of the control module 117. This may be expressed as (f(x₁,y₁)f(x₁,y₁)·f(x₂,y₂)f(x₂,y₂)<0: present in different areas).

Alternatively or additionally, if the resulting value obtained by calculating the location (f(x₁,y₁)f(x₁,y₁)) of the ego vehicle and the other point (f(x₂,y₂)f(x₂,y₂)) of the exit lane link is 0, the map handler 115a may determine that they are present on a straight line, under the control of the control module 117. This may be expressed as (f(x₁,y₁)f(x₁,y₁)·f(x₂,y₂)f(x₂,y₂)=0: present on the straight line).

Alternatively or additionally, if the resulting value obtained by calculating the location (f(x₁,y₁)f(x₁,y₁)) of the ego vehicle and the other point (f(x₂,y₂)f(x₂,y₂)) of the exit lane link is greater than 0, the map handler 115a may determine that they are present in the same area, under the control of the control module 117. This may be expressed as (f(x₁,y₁)f(x₁,y₁)·f(x₂,y₂)f(x₂,y₂)>0: present in the same area).

As described above, if it is determined that they are present in different areas, the map handler 115a may change the first exit flag (Exit Flag 0) to the second exit flag (Exit Flag 1), under the control of the control module 117. The map handler 115a may determine that the ego vehicle exits from the main road by passing through a point that was predicted as the exit point and it is not the main road until an entry is predicted again, under the control of the control module 117.

Although examples of determining a normal entry into a main road from a general road and a normal exit from the main road to the general road by the vehicle 100 through the ego vehicle location estimator 115 have been described above, examples are not limited thereto.

A method of determining whether an ego vehicle (e.g., 100) is located on a main road, although a normal entry or exit of the vehicle 100 has not been determined through the ego vehicle location estimator 115, will be described below.

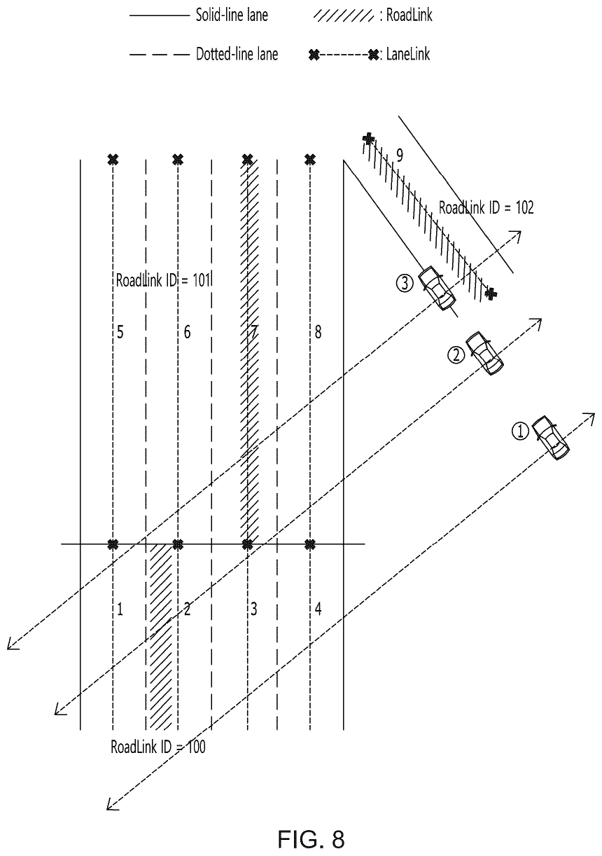

FIG. 8 shows an example of a method of determining whether a vehicle is located on a main road according to an example of the present disclosure.

Referring to FIG. 8, although a normal entry or exit is not determined for an ego vehicle (e.g., the vehicle 100) through the ego vehicle location estimator 115, a shape or form of a road link on which the ego vehicle 100 is driving may be extracted, and whether the ego vehicle 100 is present on the main rod may be determined.

According to an example of the present disclosure, at least one condition is required to be satisfied to determine the normal entry or exit of the ego vehicle 100.

First, pre-transmission information with a correct ID is required to be transmitted at an appropriate time. For example, the appropriate time may be before the ego vehicle 100 passes an entry point.

Second, a HD map is required to be input without being disconnected near an entry or exit point. That is, the HD map is required to be input before the ego vehicle 100 passes the entry point.

Third, a GPS error is required to be substantially less than 50 meters (m). For example, if the GPS error is greater than or equal to 50 m, whether the ego vehicle 100 is present on the main road may not be accurately determined because an error range is relatively wide.

According to an example of the present disclosure, if the HD map is input after the ego vehicle 100 passes the entry point, the map handler 115a may estimate or calculate a shape or form of a road link to determine an entry into the main road, under the control of the control module 117.

For example, the map handler 115a may count a counter number of crossing road links, under the control of the control module 117.

In this case, a crossing road link may be defined as a road link where a straight line perpendicular to the heading of the ego vehicle 100 meets. In this case, the road link (“RoadLink,” RL) may include a lane link (“LaneLink”). For example, the road link may include at least one lane link. Accordingly, which lane link(s) is included in a corresponding road link may be determined.

The reason for using the line perpendicular to the heading of the ego vehicle 100, rather than a lane link, is because determining a lane link closest to the ego vehicle 100 is inaccurate in the case of an entry.

As shown in FIG. 8, the map handler 115a may compare a crossing road link at a previous time (hereinafter a “previous crossing road link”) and a crossing road link at a current time (hereinafter a “current crossing road link”), and if they are determined to be different as a result of the comparing, may detect their connectivity, under the control of the control module 117. In FIG. 8, for the convenience of description, the road link will be described as being divided into a first road link (RoadLink ID=100), a second road link (RoadLink ID=101), and a third road link (RoadLink ID=102).

The first road link (RoadLink ID=100) may include a first lane link (LaneLink ID=1) to a fourth lane link (LaneLink ID=4). The second road link (RoadLink ID=101) may include a fifth lane link (LaneLink ID=5) to an eighth lane link (LaneLink ID=8). The third road link (RoadLink ID=102) may include a ninth lane link (LaneLink ID=9).

In this case, road links (“RoadLink”) of connected roads may have connectivity to each other. For example, as shown in FIG. 8, the first road link (RoadLink ID=100) has connectivity with the second road link (RoadLink ID=101), but does not have connectivity with the third road link (RoadLink ID=102).

The map handler 115a may determine or calculate the number of road links that are counted while the ego vehicle 100 is driving at points [symbol] to [symbol] , under the control of the control module 117.

For example, if the ego vehicle 100 is located at the point [symbol] , the map handler 115a may generate a straight line perpendicular to the heading of the ego vehicle 100, under the control of the control module 117. In this case, lane links that meet the generated vertical straight line may be the third lane link (LaneLink ID=3) and the fourth lane link (LaneLink ID=4).

In this case, a road link to which the third lane link (LaneLink ID=3) and the fourth lane link (LaneLink ID=4) belong may be the first road link (RoadLink ID=100), and the first road link (RoadLink ID=100) may be a current crossing road link.

As described above, if the ego vehicle 100 is located at the point [symbol] , the calculated number of crossing road links may be 1. That is, the count number of crossing road links may be 1.

If the ego vehicle 100 is located at the point [symbol] , the map handler 115a may generate a vertical straight line with respect to the heading of the ego vehicle 100, under the control of the control module 117. In this case, lane links that meet the generated vertical straight line may be the first lane link (LaneLink ID=1), the second lane link (LaneLink ID=2), the third lane link (LaneLink ID=3), and the eighth lane link (LaneLink ID=8).

In this case, a road link to which the first lane link (LaneLink ID=1), the second lane link (LaneLink ID=2), and the third lane link (LaneLink ID=3) belong may be the first road link (RoadLink ID=100), and a road link to which the eighth lane link (LaneLink ID=8) belongs may be the second road link (RoadLink ID=101). Accordingly, the first road link (RoadLink ID=100) and the second road link (RoadLink ID=101) may be current crossing road links.

As described above, if the ego vehicle 100 is located at the point [symbol] , the calculated number of crossing road links may be 2.

In this case, for the ego vehicle 100, the first road link (RoadLink ID=100) was the current crossing road link at the point [symbol] , but the first road link (RoadLink ID=100) of the point [symbol] may become a previous crossing road link and the first road link (RoadLink ID=100) and the second road link (RoadLink ID=101) may become the current crossing road links at the point [symbol] .

At the point [symbol] , the second road link (RoadLink ID=101) is added compared to the point [symbol] , and thus the map handler 115a may compare the previous crossing road link and the current crossing road link and determine their connectivity based on a result of the comparison, under the control of the control module 117.

For example, the map handler 115a may compare the first road link (RoadLink ID=100) that is the previous crossing road link at the point [symbol] and the first road link (RoadLink ID=100) and the second road link (RoadLink ID=101) that are the current crossing road links at the point [symbol] , and determine the presence or absence of connectivity between them because they are different based on a result of the comparison, under the control of the control module 117.

That is, at the point [symbol] , the map handler 115a may compare the first road link (RoadLink ID=100) and the second road link (RoadLink ID=101), and if the first road link (RoadLink ID=100) and the second road link (RoadLink ID=101) are different, may determine whether there is connectivity therebetween, under the control of the control module 117.

If it is determined that the first road link (RoadLink ID=100) and the second road link (RoadLink ID=101) are different and there is the connectivity therebetween, the map handler 115a may delete the second road link (RoadLink ID=101) from the current crossing road links, under the control of the control module 117. Accordingly, the first road link (RoadLink ID=100) may become a final road link at a current time (or a current road link) and the number of crossing road links may become 1. That is, the count number of crossing road links may be 1.

If the ego vehicle is located at the point [symbol] , the map handler 115a may generate a vertical straight line with respect to the heading of the ego vehicle 100, under the control of the control module 117. In this case, lane links that meet the generated vertical straight line may be the first lane link (LaneLink ID=1), the sixth lane link (LaneLink ID=6), the seventh lane link (LaneLink ID=7), the eighth lane link (LaneLink ID=8), and the ninth lane link (LaneLink ID=9).

In this case, a road link to which the first lane link (LaneLink ID=1) belongs may be the first road link (RoadLink ID=100), and a road link to which the sixth lane link (LaneLink ID =6), the seventh lane link (LaneLink ID=7), and the eighth lane link (LaneLink ID=8) belong may be the second road link (RoadLink ID=101). In addition or alternative, a road link to which the ninth lane link (LaneLink ID=9) belongs may be the third road link (RoadLink ID=102). Accordingly, the first road link (RoadLink ID=100), the second road link (RoadLink ID=101), and the third road link (RoadLink ID=102) may be current crossing road links.

As described above, if the ego vehicle 100 is located at the point [symbol] , the calculated number of crossing road links may be 3.

In this case, for the ego vehicle 100, the first road link (RoadLink ID=100) was the current crossing road link at the point [symbol] , but the first road link (RoadLink ID=100) of the point [symbol] may become the previous crossing road link at the point [symbol] and the first, second, and third road links may become the current crossing road links.

At the point [symbol] , the third road link (RoadLink ID=102) is added compared to the point [symbol] , and thus the map handler 115a may compare the previous crossing road link and the current crossing road links and determine the presence or absence of connectivity therebetween, under the control of the control module 117.

For example, the map handler 115a may compare the first road link (RoadLink ID=100) that is the previous crossing road link at the point [symbol] , and the first road link (RoadLink ID=100), the second road link (RoadLink ID=101), and the third road link (RoadLink ID=102) that are the current crossing road links at the point [symbol] , and may determine their connectivity because they are different as a result of the comparison, under the control of the control module 117.

That is, at the point [symbol] , the map handler 115a may compare the first load link (RoadLink ID=100) and the second road link (RoadLink ID=101) and, if the first road link (RoadLink ID=100) and the second road link (RoadLink ID=101) are different, may determine whether there is connectivity therebetween, under the control of the control module 117.

If it is determined that the first road link (RoadLink ID=100) and the second road link (RoadLink ID=101) are different and that there is connectivity therebetween, the map handler 115a may delete the second road link (RoadLink ID=101) from the current crossing road links, under the control of the control module 117.

In addition or alternative, if it is determined that the first road link (RoadLink ID=100) and third road link (RoadLink ID=102) are different and that there is not connectivity therebetween, the map handler 115a may not delete the third road link (RoadLink ID=102) from the current crossing road links, under the control of the control module 117.

Accordingly, the first road link (RoadLink ID=100) and the third road link (RoadLink ID=102) may become final current road links, and the number of crossing road links may become 2. That is, the count number of crossing road links may be 2.

As described above, under the control of the control module 117, if n road links that are current crossing road links and m road links that are previous crossing road links are different, the map handler 115a may determine the presence or absence of connectivity between the n road links and the m road links, and delete a corresponding road link from the n road links that are the current crossing road links if there is connectivity, and maintain the corresponding road link in the n road links that are current crossing road links if there is not connectivity. In this case, n and m may denote natural numbers greater than or equal to 1.

Subsequently, the map handler 115a may determine whether the ego vehicle 100 is driving on the main road based on the calculated count number of crossing road links, under the control of the control module 117.

That is, although an entry property is not normally determined, it may be determined or estimated that there is a possibility of driving on the main road if there is a significant change in the number of lanes on a HD map, which may enable a normal execution of a positioning operation.

If, through comparison with a previous time point, the count number of crossing road links increases or decreases while the entry flag (Flag) is the second entry flag (Entry Flag 1), the map handler 115a may determine the driving on the main road, under the control of the control module 117. Accordingly, the map handler 115a may initialize the second entry flag (Entry Flag 1) to the first entry flag (Entry Flag 0) under the control of the control module 117.

In contrast, if a distance between the ego vehicle 100 and the entry point is substantially less than 20 m, the map handler 115a may determine that the calculation for a normal entry is relatively accurate and may not initialize the entry flag, under the control of the control module 117.

In addition or alternative, if the number of lane links included in a road link does not substantially change even if the number of road links changes, the map handler 115a, may not initialize the entry flag, under the control of the control module 117.

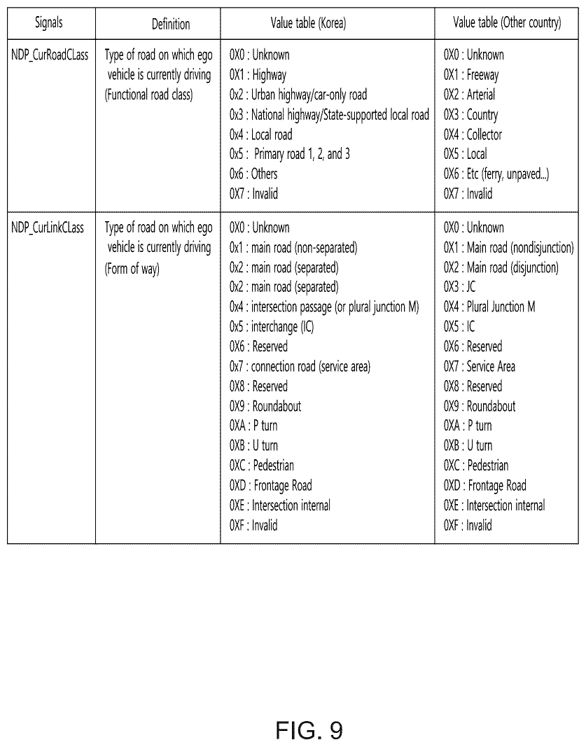

FIG. 9 shows an example of a method of determining whether a vehicle is located on a main road according to another example of the present disclosure.

Referring to FIG. 9, according to an example of the present disclosure, even if a normal entry or exit of the ego vehicle 100 is not determined through the ego vehicle location estimator 115, whether the ego vehicle 100 is present on a main road may be determined using navigation information.

The map handler 115a may receive navigation information from the navigation controller 130 and analyze it under the control of the control module 117. For example, the map handler 115a may receive the navigation information about a road on which the ego vehicle 100 is located and analyze the provided navigation information, and generate road type information, under the control of the control module 117. The navigation information may also be referred to as navigation road information.

The navigation information may include road type information. For example, the road type information may include information about whether a road is a main road, an interchange (IC) or junction (JC), a road indicated as “else,” and the like.

The map handler 115a may generate the road type information or type information by combining the navigation information and class information shown in FIG. 9, under the control of the control module 117. The class information shown in FIG. 9 may be stored in advance in a memory described above.

The class information may be classified into “NDP_CurRoadClass” and “NDP_CurLinkClass.” For example, “NDP_CurRoadClass” may indicate a type of a road (e.g., highways, city streets, rural roads, residential streets, mountain roads, gravel or dirt roads, expressways, toll roads, bridges and overpasses, tunnels, etc.) on which the ego vehicle 100 is currently driving. For example, in NDP_CurRoadClass, “0x0” may indicate “unknown,” “0x1” may indicate a highway, “0x2” may indicate an urban highway/car-only road, “0x3” may indicate a national highway/state-supported local road, “0x4” may a local road, “0x5” may primary road 1, 2, and 3, “0x6” may indicate others, “0x7” may indicate “invalid.”

In addition or alternative, “NDP_CurLinkClass” may indicate a form of the road on which the ego vehicle 100 is currently driving. For example, in NDP_CurLinkClass, “0x0” may indicate “unknown,” “0x1” may indicate a main road (non-separated), “0x2” may indicate a main road (separated), “0x3” may indicate a junction (JC), “0x4” may indicate an intersection passage (or plural junction M), “0x5” may indicate an interchange (IC), “0x6” may indicate “reserved,” “0x7” may indicate a connection road (service area), . . . , and “0xF” may indicate “invalid.”

The road type information described above is information about a road on which the ego vehicle 100 is located that is received from the navigation controller 130, even if a location error of the ego vehicle 100 used in a HD map is relatively large, and may thus be relatively highly reliable.

The map handler 115a may analyze the generated road type information and initialize an entry flag or an exit flag based on a result of the analysis, under the control of the control module 117.

For example, if the road type information is changed from “not main” (e.g., IC/JC and else) to “main” in a state of a second entry flag (Entry Flag 1), the map handler 115a may initialize the entry flag to a first entry flag (Entry Flag 0), under the control of the control module 117.

In addition or alternative, if a distance between the ego vehicle 100 and an entry point is substantially less than or equal to 20 m, the map handler 115a may determine that the calculation for a normal entry is relatively accurate and may not initialize the entry flag to the first entry flag (Entry Flag 0), under the control of the control module 117.

In addition or alternative, if the road type information is changed from “not main” (e.g., IC/JC, else) to “main” while in a state of a second exit flag, the map handler 115a may initialize the exit flag to a first exit flag (Exit Flag 0), under the control of the control module 117.

The map handler 115a may operate regardless of a distance between the ego vehicle 100 and an exit point, under the control of the control module 117.

In addition or alternative, according to an example of the present disclosure, even if a normal entry or exit of the ego vehicle 100 is not determined using the ego vehicle location estimator 115, whether the ego vehicle 100 is present on a main road may be determined using a distance to an entry point to a service area.

For example, the service area may not be included in geometry information of a HD map.

Therefore, in the case of an entry into the main road from the service area, positioning reliability may be low, as in the case of first entering the main road, and autonomous driving operation conditions may not be satisfied quickly.

In consideration of this, when the exit flag operates by an exit from the main road to the service area, the map handler 115a may accumulate and calculate a driving distance based on service area entry information stored after the entry into the main road from the service area, under the control of the control module 117.

That is, in the case of driving a predetermined driving distance on the main road after the exit from the service area, the map handler 115a may forcibly initialize the exit flag to the first exit flag (Exit Flag 0), under the control of the control module 117. In this case, the predetermined driving distance may be substantially 600 m.

As described above, in the case of driving the predetermined driving distance on the main road after the exit from the service area, the map handler 115a may forcibly initialize the exit flag to the first exit flag (Exit Flag 0) and may thereby allow the ego vehicle 100 to drive stably, under the control of the control module 117.

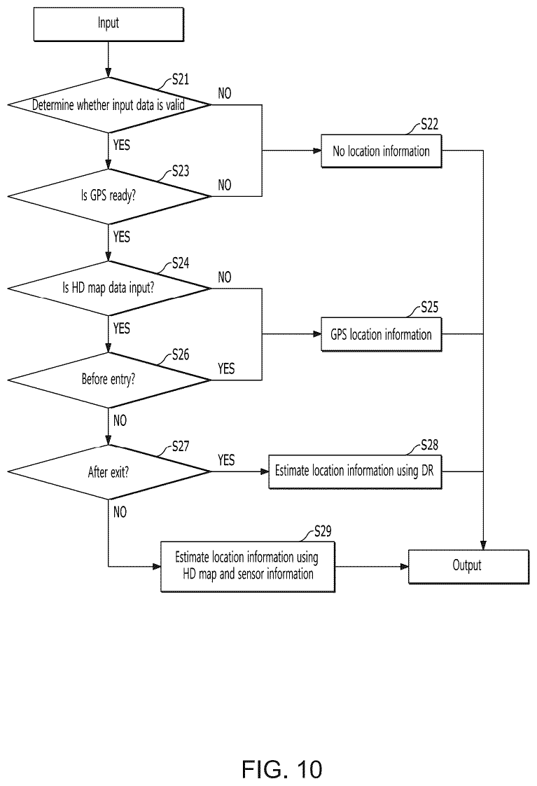

FIG. 10 shows an example of a flowchart showing operations of an autonomous driving controller according to an example of the present disclosure.

Referring to FIG. 10, according to an example of the present disclosure, the operations of the autonomous driving controller 110 are as follows.

In step S21, the autonomous driving controller 110 may receive GPS information provided by the navigation controller 130, HD map information, and sensor data, and determine whether such input data is valid.

If it is determined that the input data is invalid (No in S21), the autonomous driving controller 110 may output information indicating that there is no location information and may set a precision positioning state to be a not-ready state (“Not Ready”), in step S22.

In contrast, if it is determined that the input data is valid (Yes in S21), the autonomous driving controller 110 may set a GPS to be in a ready state (“Ready”) in step S23.

If the GPS is not in the ready state (No in S23) while the input data is determined to be valid in step S23, the autonomous driving controller 110 may determine that the GPS information is invalid and output the information indicating that there is no location information in step S22, and may set the precision positioning state to be the not-ready state.

If the HD map information is not input (No in S24) while the GPS is in the ready state, the autonomous driving controller 110 may output the GPS information as is because only the GPS information is valid in step S25. In this case, the GPS information may be referred to as GPS location information.

Accordingly, since only the GPS information is known and there is no HD map information, the autonomous driving controller 110 may set the precision positioning state to be the not-ready state.

If the HD map information is input (Yes in S24) while the GPS is in the ready state, the autonomous driving controller 110 may determine an entry into a main road from a general road in step S26. For example, if it is before the ego vehicle 100 enters the main road from the general road (Yes in S26), the autonomous driving controller 110 may output the GPS information in step S25 and set the precision positioning state to be the not-ready state.

That is, if it is before the ego vehicle 100 enters the main road from the general road (Yes in S26), the autonomous driving controller 110 may output the GPS information as is in step S25 because the input HD map does not correspond to a road on which the ego vehicle 100 is currently driving. In this case, since the GPS information does not meet the specifications, the precision positioning state may be set to be the not-ready state.

If it is before the ego vehicle 100 exits (No in S27) after entering the main road from the general road (No in S26), the autonomous driving controller 110 may determine that the input HD map information is valid and estimate location information of the ego vehicle 100 using the HD map and the sensor information in step S29. In this case, the autonomous driving controller 110 may set the precision positioning state to be a ready state (“Ready”).

In contrast, if it is after the ego vehicle 100 exits to the main road from the general road (Yes in S27), the autonomous driving controller 110 may estimate the location information by applying dead reckoning (DR) to previous location information in step S28 because the input HD map does not correspond to the road on which the ego vehicle 100 is currently driving. The DR may estimate a location using vehicle dynamics information.

In this case, a result of estimating the location using the DR may correspond to location information estimated only for a preset distance. Accordingly, the precision positioning state may be set to be the not-ready state after driving a certain distance with the precision positioning state maintained as the ready state.

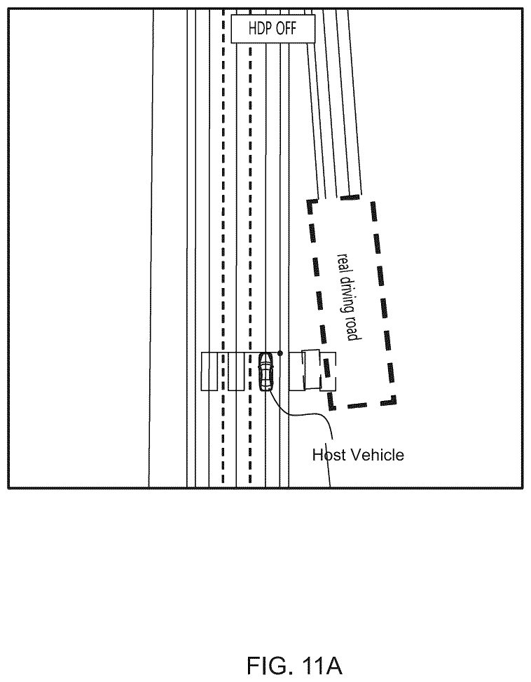

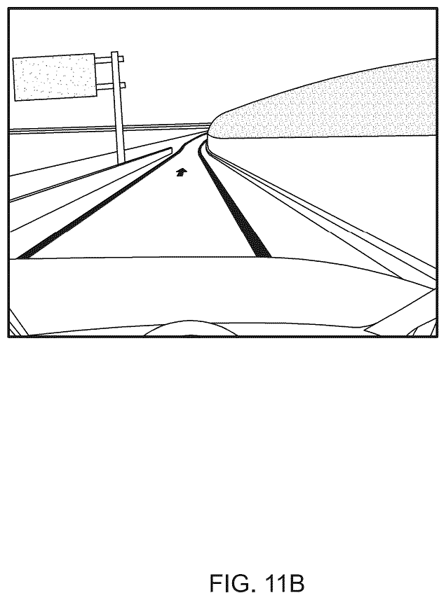

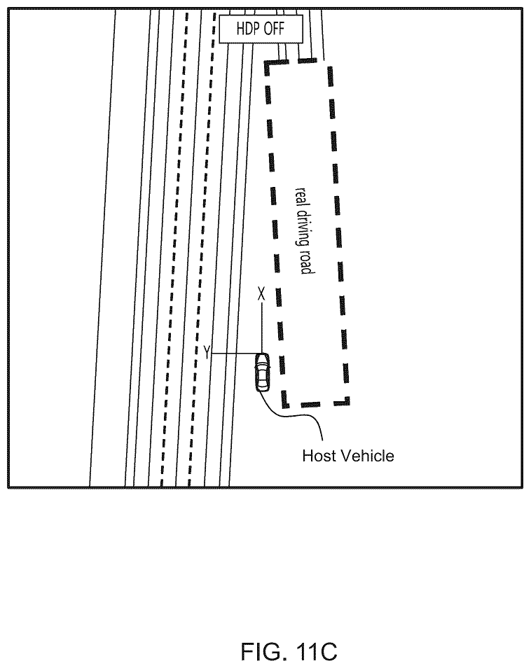

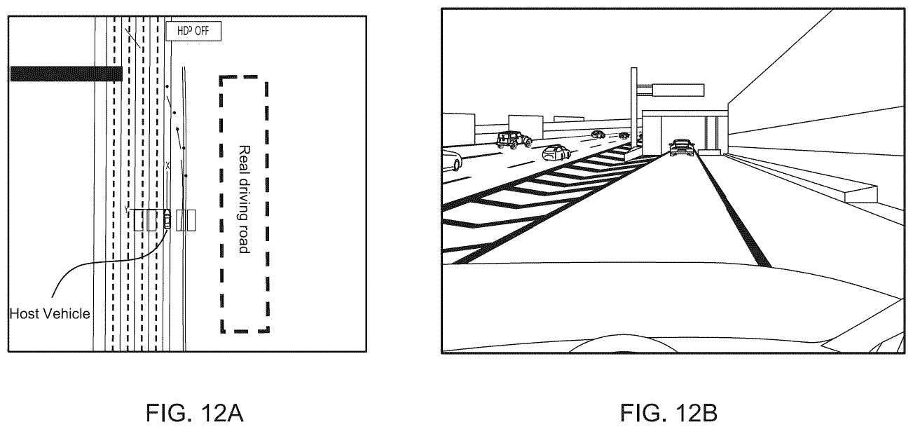

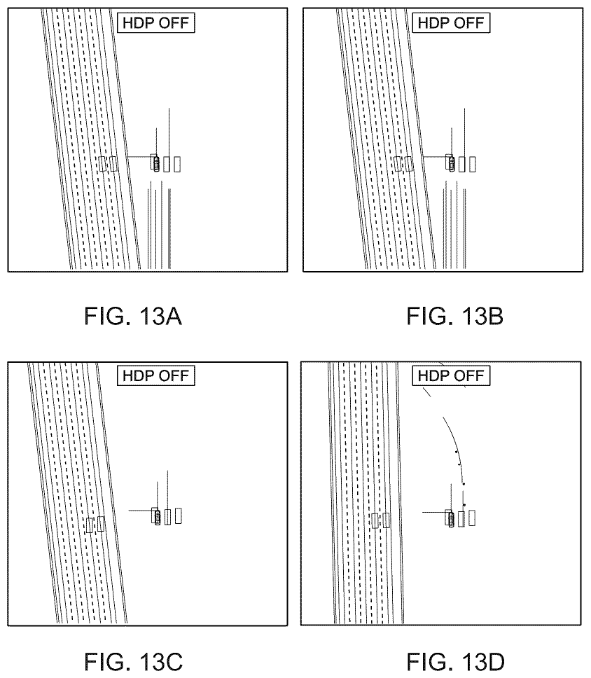

FIG. 11A, FIG. 11B, FIG. 11C, FIG. 12A, FIG. 12B, FIG. 13A, FIG. 13B, FIG. 13C, and FIG. 13D shows examples of simulations according to an example of the present disclosure.

In FIG. 11A, FIG. 11B, FIG. 11C, FIG. 12A, FIG. 12B, FIG. 13A, FIG. 13B, FIG. 13C, and FIG. 13D, an area indicated by a red dotted line indicates a real driving road. In addition or alternative, a green box indicates a GPS location, and a white box indicates an ego vehicle (e.g., 100).

FIG. 11A shows matching on the real driving road due to a GPS error, FIG. 11B shows an image captured during real driving, and FIG. 11C shows how a GPS location is maintained and output, based on a determination that it is an entry situation.

According to an example of the present disclosure, the autonomous driving controller 110 may determine that the ego vehicle 100 is in a state before entering a main road based on a GPS error and maintain a GPS location based on a result of the determination to set a precision positioning state to be a not-ready state (“Not Ready”).

FIG. 12A shows matching on a car-only road while driving on a parallel general road after exiting the car-only road, and FIG. 12B shows an image captured during real driving. In addition or alternative, FIG. 13A shows how an exit situation is determined according to an example of the present disclosure, FIG. 13B shows location estimation using DR, and FIG. 13C shows how matching on a car-only road is prevented, and FIG. 13D shows how a precision positioning state is set to be a not-ready state (“Not Ready”) after driving a certain distance.

According to an example of the present disclosure, in the case of an exit from a car-only road to a general road, the autonomous driving controller 110 may estimate location information by applying DR to previous location information because an input HD map does not correspond to a road on which the ego vehicle 100 is currently driving. The DR may estimate a location using vehicle dynamics information. Accordingly, the precision positioning state may be set to be the not-ready state after the ego vehicle 100 drives a certain distance with the precision positioning state maintained as a ready state.

An object of the present disclosure is to provide an autonomous vehicle and a method of controlling the autonomous vehicle, which may determine an entry/exit state of a car-only road and prevent a ready state (“Ready”) of precision positioning from being erroneously activated on a general road, which is not a car-only road, based on a result of the determining.

According to an example of the present disclosure, there is provided an autonomous vehicle comprising an autonomous driving controller, wherein the autonomous driving controller is configured to: receive global positioning system (GPS) information, HD (High Definition) map information, road information related one or more roads ahead, and sensor information; and generate road change information related to whether the vehicle entries onto or exits from a road of a preset class using the global positioning system (GPS) information, the HD (High Definition) map information, the road information, and the sensor information.

In at least one example, the autonomous driving controller is further configured to set a precision positioning state to be a ready state according to the road change information.

In at least one example, the autonomous driving controller is further configured to output the GPS information and set the precision positioning state to be a not-ready state in response that the vehicle is determined to be in a state before entering the road of the preset class.

In at least one example, the autonomous driving controller is further configured to, in response that the autonomous vehicle is determined to be in a state after exiting the road of the preset class, estimate a location of the autonomous vehicle by applying dead reckoning (DR) to a previous location, and set the precision positioning state to be a not-ready state.

In at least one example, the autonomous driving controller is further configured to when using the DR, estimate the location of the autonomous vehicle within a preset distance.

In at least one example, the autonomous driving controller is further configured to when using the DR, maintain the precision positioning state as the ready state until within the preset distance, and set the precision positioning state to be the not-ready state after the preset distance.

In at least one example, the HD map information comprises a road link property and a lane link geometry of the road of the preset class, and the road information comprises a road identification (ID) of the road of the preset class.

In at least one example, the autonomous driving controller is further configured to, in response that the ID indicates a null signal, set an entry flag to be a first entry flag, in response that the ID is changed from an ID indicating a general road to an ID indicating a road of the preset class, set the entry flag to be a second entry flag, and in response that the ID is changed to an ID indicating a road of the preset class, set the entry flag to be a third entry flag.

In at least one example, the first entry flag indicates a case where the autonomous vehicle is not entering onto a road of the preset class, the second entry flag indicates a case where the autonomous vehicle is entering onto the road of the preset class, and the third entry flag indicates a case where the road of the preset class is changed to a road of the preset class due to a change of a driving path of the vehicle.

In at least one example, the road information includes information related to a road which is determined to be most likely to be travelled on by the vehicle among a plurality of roads at a road junction or bifurcation ahead.

According to another example of the present disclosure, there is provided a method of controlling an autonomous vehicle comprising an autonomous driving controller, the method comprising receiving, by the autonomous driving controller, global positioning system (GPS) information, HD (High Definition) map information, road information related one or more roads ahead, and sensor information, and generating, by the autonomous driving controller, road change information related to whether the vehicle entries onto or exits from a road of a preset class using the global positioning system (GPS) information, the HD map information, the road information, and the sensor information.

In at least one example of the method, the method further comprises setting a precision positioning state to be a ready state according to the road change state information.

In at least one example of the method, the method further comprises outputting the GPS information and setting the precision positioning state to be a not-ready state in response that the vehicle is determined to be in a state before entering the road of the preset class.

In at least one example of the method, the method further comprises, in response that the autonomous vehicle is determined to be in a state after exiting the road of the preset class, estimating a location of the autonomous vehicle by applying dead reckoning (DR) to a previous location, and setting the precision positioning state to be a not-ready state.

In at least one example of the method, the method further comprises when using the DR, estimating the location of the autonomous vehicle within a preset distance.

In at least one example of the method, the method further comprises when using the DR, maintaining the precision positioning state to be the ready state until within the preset distance, and setting the precision positioning state to be the not-ready state after the preset distance.

In at least one example of the method, the HD map information comprises a road link property and a lane link geometry of the road of the preset class, and the road information comprises a road identification (ID) of the road of the preset class.

In at least one example of the method, the method further comprises, in response that the ID indicates a null signal, setting an entry flag to be a first entry flag, in response that the ID is changed from an ID indicating a general road to an ID indicating a road of the preset class, setting the entry flag to be a second entry flag, and in response that the ID is changed to an ID indicating a road of the preset class, setting the entry flag to be a third entry flag.

In at least one example of the method, the first entry flag indicates a case where the autonomous vehicle is not entering onto a road of the preset class, the second entry flag indicates a case where the autonomous vehicle is entering onto the road of the preset class, and the third entry flag indicates a case where the road of the preset class is changed to a road of the preset class due to a change of a driving path of the vehicle.

According to an example of the present disclosure, there is provided a non-transitory computer-readable storage medium storing a program or instructions for implementing the method above by being executed by a processor.

According to examples of the present disclosure described herein, an autonomous vehicle and a method of controlling the autonomous vehicle may determine a car-only road entry/exit state of the autonomous vehicle driving on a road and prevent a ready state (“Ready”) of precision positioning from being activated on a general road that is not a car-only road based on a result of the determining.

In addition or alternative, the autonomous vehicle and the method of controlling the autonomous vehicle may determine a car-only road entry/exit state of the autonomous vehicle driving on a road and prevent a ready state of precision positioning from being activated on a general road that is not a car-only road based on a resulting value from the determining, thereby preventing a highway driving pilot (HDP) from operating in an unexpected environment.

In addition or alternative, the autonomous vehicle and the method of controlling the autonomous vehicle may determine a road change state e.g. a car-only road entry/exit state of the autonomous vehicle and prevent a ready state of precision positioning from being activated on a general road that is not a car-only road based on a resulting value from the determining, thereby preventing an HDP from operating in an unexpected environment and improving the driver's safety.

In addition or alternative, the autonomous vehicle and the method of controlling the autonomous vehicle may determine a car-only road entry/exit state of the autonomous vehicle driving on a road and prevent a ready state of precision positioning from being activated on a general road that is not a car-only road based on a resulting value from the determining, thereby preventing an HDP from operating in an unexpected environment and improving the reliability of the autonomous vehicle.

The method according to example examples of the present disclosure may be embodied as a computer-executable program and stored in a computer-readable storage medium.

Examples of the computer-readable storage medium include a read-only memory (ROM), a random-access memory (RAM), a CD-ROM, a magnetic tape, a floppy disk, an optical data storage device, and the like. The computer-readable storage medium may be distributed in a computer system connected over a network such that computer-readable code is stored and executed in a distributed manner. In addition or alternative, functional programs, codes, and code segments for implementing the method described above may be easily inferred by programmers in the technical field to which the examples pertain.

The various examples described above may be combined with each other as long as they do not deviate from the purpose of the present disclosure and do not conflict with each other. In addition or alternative, among the various examples described above, if a component of an example is not described in detail, the description of a component having the same reference numeral in other examples may be applied mutatis mutandis.

While the present disclosure has been described with various example examples, it will be apparent after an understanding of the disclosure that various modifications and changes in form and details may be made without departing from the spirit and scope of the claims and their equivalents. The examples described herein are to be considered in a descriptive sense only, and not for purposes of limitation. Therefore, in addition or alternative to the foregoing description, the scope of the disclosure may also be defined by the claims and their equivalents, and all variations within the scope of the claims and their equivalents are to be construed as being included in the disclosure.

What is claimed is:

1. An apparatus for controlling an autonomous driving of a vehicle, the apparatus comprising:
a controller; and
memory storing instructions, when executed by the controller, configured to cause the apparatus to:
receive global positioning system (GPS) information, High Definition (HD) map information, road information, and sensor information, wherein the GPS information, the HD map information, and the road information are related to one or more roads ahead of the vehicle;
generate, based on the GPS information, the HD map information, road information, and the sensor information, road change information, wherein the road change information is related to whether a driving road which the vehicle travels on is changed to or from a road, and wherein the road is associated with a preset class; and
output, based on the road change information, a signal for controlling the autonomous driving of the vehicle.

2. The apparatus of claim 1, wherein the instructions, when executed by the controller, are further configured to cause the apparatus to:
set, based on the road change information, a precision positioning state of the vehicle to be a ready state of the vehicle.

3. The apparatus of claim 2, wherein the instructions, when executed by the controller, are further configured to cause the apparatus to:
output the GPS information; and
set, based on the vehicle being determined to be in a state before entering a road associated with the preset class, the precision positioning state to be a not-ready state of the vehicle.

4. The apparatus of claim 2, wherein the instructions, when executed by the controller, are further configured to cause the apparatus to:
based on the vehicle being determined to be in a state after exiting a road associated with the preset class,
estimate a location of the vehicle by applying dead reckoning (DR) to a previous location; and
set the precision positioning state to be a not-ready state of the vehicle.

5. The apparatus of claim 4, wherein the instructions, when executed by the controller, are further configured to cause the apparatus to:
estimate, based on using the DR, the location of the vehicle within a preset distance.

6. The apparatus of claim 5, wherein the instructions, when executed by the controller, are further configured to cause the apparatus to:
maintain, based on using the DR, the precision positioning state as the ready state until the vehicle is within the preset distance; and
set the precision positioning state to be the not-ready state after the vehicle is beyond the preset distance.

7. The apparatus of claim 1, wherein the HD map information comprises a road link property and a lane link geometry of the road associated with the preset class, and
the road information comprises a road identification (ID) of the road associated with the preset class.

8. The apparatus of claim 7, wherein the instructions, when executed by the controller, are further configured to cause the apparatus to:
based on the ID indicating a null signal, set an entry flag to be a first entry flag, wherein the entry flag indicates information associated with situations under which the vehicle is entering a road;
based on the ID being changed from an ID indicating a general road to an ID and
based on the ID being changed to an ID indicating a road associated with the preset class, set the entry flag to be a third entry flag.

9. The apparatus of claim 8, wherein the first entry flag indicates a case where the vehicle is not entering onto a road associated with the preset class,
the second entry flag indicates a case where the vehicle is entering onto a road associated the preset class, and
the third entry flag indicates a case where a road of the preset class is changed to another road associated with the preset class due to a change of a driving path of the vehicle.

10. The apparatus of claim 1, wherein the road information comprises information related to a most likely road, wherein the most likely road is determined to be most likely to be travelled on by the vehicle among a plurality of roads at a road junction or bifurcation ahead.

11. A method for controlling an autonomous driving of a vehicle, the method comprising:
receiving, by a controller, global positioning system (GPS) information, High Definition (HD) map information, road information, and sensor information, wherein the GPS information, the HD map information, and the road information are related to one or more roads ahead of the vehicle; and
generating, by the controller and based on the GPS information, the HD map information, the road information, and the sensor information, road change information, wherein the road change information is related to whether a driving road which the vehicle travels on is changed to or from a road, and wherein the road is associated with a preset class; and
outputting, based on the road change information, a signal for controlling the autonomous driving of the vehicle.

12. The method of claim 11, further comprising setting, based on the road change information, a precision positioning state of the vehicle to be a ready state of the vehicle.

13. The method of claim 12, further comprising:
outputting the GPS information; and
setting, based on the vehicle being determined to be in a state before entering a road associated with the preset class, the precision positioning state to be a not-ready state of the vehicle.

14. The method of claim 12, further comprising:
based on the vehicle being determined to be in a state after exiting a road associated with the preset class,
estimating a location of the vehicle by applying dead reckoning (DR) to a previous location; and
setting the precision positioning state to be a not-ready state of the vehicle.

15. The method of claim 14, further comprising estimating, based on using the DR, the location of the vehicle within a preset distance.

16. The method of claim 15, further comprising:
maintaining, based on using the DR, the precision positioning state to be the ready state until the vehicle is within the preset distance; and
setting the precision positioning state to be the not-ready state after the vehicle is beyond the preset distance.

17. The method of claim 11, wherein the HD map information comprises a road link property and a lane link geometry of the road associated with the preset class, and
the road information comprises a road identification (ID) of the road associated with the preset class.

18. The method of claim 17, further comprising:
based on the ID indicating a null signal, setting an entry flag to be a first entry flag, wherein the entry flag indicates information associated with situations under which the vehicle is entering a road;
based on the ID being changed from an ID indicating a general road to an ID indicating a road associated the preset class, setting the entry flag to be a second entry flag; and
based on the ID being changed to an ID indicating a road associated with the preset class, setting the entry flag to be a third entry flag.

19. The method of claim 18, wherein the first entry flag indicates a case where the vehicle is not entering onto a road associated with the preset class,
the second entry flag indicates a case where the vehicle is entering onto a road associated with the preset class, and
the third entry flag indicates a case where a road associated with the preset class is changed to another road associated with the preset class due to a change of a driving path of the vehicle.

20. A non-transitory computer-readable medium storing a program or instructions, when executed, cause performance of the method of claim 11.
